(19) United States
(12) Patent Application Publication
(10) Pub. No.: US 2026/0330986 A1
(43) Pub. Date: Oct. 22, 2026

(54) MODULAR EDUCATIONAL DEVICE WITH ROTATABLE CHARACTER RINGS FOR INTERACTIVE LEARNING

(71) Applicant: SAGAR ANAND KANASE, TORONTO (CA)

(72) Inventor: SAGAR ANAND KANASE, TORONTO (CA)

(21) Appl. No.: 19/531,665

(22) Filed: Feb. 6, 2026

(30) Foreign Application Priority Data
Feb. 6, 2025 (CA) 3264398

(51) Int. Cl. G09B 1/06; G06V 20/62; G06V 30/19; G09B 5/02

(52) U.S. Cl. CPC G09B 1/06; G06V 20/63; G06V 30/19; G09B 5/02

(57) ABSTRACT

A modular educational device is disclosed for facilitating interactive, hands-on learning. The device includes a plurality of display modules, each display module having a housing and a movable character carrier retained within the housing. The character carrier is configured to selectively present one of a plurality of characters through a viewing region of the housing by movement of the character carrier relative to the housing. The display modules are detachably connectable to form configurable sequences for collectively presenting characters to form words, numbers, symbols, or patterns. In certain embodiments, the device is usable with an external computing device including a camera and a processor configured to capture image data representing the presented characters and to generate instructional output based on recognition of the characters. The modular educational device supports tactile interaction, modular reconfiguration, and optional digital feedback while remaining suitable for standalone mechanical use.

### CROSS REFERENCE TO RELATED APPLICATIONS

This application claims priority to Canadian Patent Application No. 3,264,398, filed on Feb. 6, 2025, entitled “Modular Educational Device with Rotatable Character Rings for Interactive Learning”, the entire contents of which are hereby incorporated by reference in their entirety for all purposes.

### FIELD OF THE INVENTION

The present invention relates generally to educational devices and learning aids, and more particularly to a modular, manually operable educational device for presenting selectable characters. The invention pertains to the fields of educational toys, literacy and numeracy teaching tools, and interactive learning systems, and is directed to a modular apparatus having movable character carriers configured to display characters for forming words, numbers, symbols, or patterns. The invention further relates to educational devices that may be used independently as physical learning tools or in combination with external computing devices employing image-based recognition to provide interactive and adaptive instructional feedback.

### BACKGROUND OF THE INVENTION

Educational toys and learning devices have long been used to support the development of literacy, numeracy, and cognitive skills, particularly in early childhood education. Traditional educational aids such as alphabet blocks, flashcards, letter tiles, spelling boards, and number charts provide tactile interaction that helps learners associate visual symbols with sounds, meanings, and numerical concepts. While these tools have proven effective in basic instruction, they often lack adaptability, engagement, and scalability for varying learning levels and modern educational environments.

Many conventional spelling and learning tools require users to select individual characters from a large collection of separate pieces. This approach can be cumbersome, time-consuming, and cognitively overwhelming, especially for young children or learners with limited attention spans. The need to search for and manage numerous loose components frequently interrupts the learning flow, reduces engagement, and increases the likelihood of misplaced or lost pieces. Additionally, such systems typically offer limited reconfigurability and do not easily support incremental learning or creative experimentation.

Various mechanical educational toys have been developed to address some of these limitations by incorporating movable or rotatable character elements. For example, certain prior art devices employ spinners, wheels, sleeves, or annular rings bearing alphanumeric characters that can be rotated to display different letters or symbols. While these devices reduce the number of loose parts and allow multiple characters to be accessed from a single component, they are often constrained by fixed structures, limited modularity, or rigid mechanical arrangements. Many such devices rely on a single shaft, axle, or housing that restricts the number of characters that can be displayed simultaneously or prevents flexible reordering of characters to form different words or expressions.

Other educational devices introduce modularity by allowing multiple units or blocks to be connected together. However, these systems frequently depend on simple stacking or adjacency without providing a seamless and intuitive mechanism for combining character selection and modular reconfiguration. In many cases, the modular components are static, requiring the user to replace entire units to change characters rather than allowing dynamic selection within each unit. This limits the versatility of the device and reduces opportunities for exploratory learning.

Additionally, several prior art solutions incorporate electronic components, sensors, or embedded circuitry to detect character positions or user interactions. While such systems may provide automated feedback, they often increase manufacturing complexity, cost, and power requirements. Embedded electronics may also reduce durability and make the devices less suitable for young children. Furthermore, sensor-based detection systems typically require precise alignment, calibration, or specialized hardware, which can limit accessibility and ease of use.

In recent years, digital learning platforms and mobile applications have become increasingly prevalent in educational environments. These platforms offer adaptive learning, progress tracking, and interactive feedback. However, purely digital learning tools often lack the tactile and kinesthetic engagement provided by physical manipulatives. As a result, learners may experience reduced sensory involvement and diminished retention when interacting solely with screens. Attempts to bridge physical and digital learning have been limited by the need for specialized electronics within physical devices or by cumbersome interfaces that detract from intuitive play.

Accordingly, there exists a need for an educational device that combines the tactile benefits of physical learning tools with the adaptability, modularity, and engagement of modern interactive systems. Such a device should allow users to easily select and change characters without managing numerous loose components, support flexible arrangement of multiple units to form words, numbers, or patterns, and remain intuitive and robust for independent use by children. There is further a need for a solution that can optionally integrate with digital technologies—such as smartphones or tablets—without requiring complex or costly electronics embedded within each physical unit.

The present invention addresses these needs by providing a modular educational device composed of individual units, each containing a rotatable character ring housed within a structure that displays a selected character through a viewing window. The units are configured with connection mechanisms that enable multiple units to be detachably connected in customizable sequences, allowing learners to form words, numerical expressions, symbols, or creative patterns. By enabling character selection through simple rotation within each unit, the invention reduces cognitive load and enhances engagement while maintaining a compact and organized form factor.

Moreover, the invention is designed to be compatible with external digital recognition technologies, such as computer vision-based applications operating on smartphones or tablets. This approach enables interactive feedback, guided learning activities, and progress tracking without requiring embedded sensors or electronics within the physical device itself. As a result, the invention provides a cost-effective, durable, and highly adaptable educational tool that bridges physical and digital learning in a manner not adequately addressed by existing prior art.

### SUMMARY OF THE INVENTION

The present invention relates to a modular educational device designed to facilitate interactive, hands-on learning through controlled physical manipulation of characters and optional digital interaction. The invention provides a versatile learning platform that supports literacy, numeracy, cognitive development, and creative expression, while remaining intuitive, durable, and adaptable for users of varying ages and skill levels.

In one exemplary embodiment, the modular educational device comprises a plurality of display modules, each module including a housing that retains a movable character carrier. The movable character carrier is configured to selectively present one of a plurality of characters, such as letters, numbers, symbols, or pictorial representations. The character carrier may be implemented in various forms, including but not limited to a rotatable ring, wheel, drum, or other movable element, thereby allowing broad applicability beyond a single geometric configuration.

Each housing includes a viewing window or viewing region through which only a selected character from the movable character carrier is visible at any given time. Movement of the character carrier relative to the housing, such as by rotation, causes different characters to align with the viewing window for display. This controlled presentation limits visual clutter, reduces cognitive load, and enables focused learning by allowing users to engage with one character per module at a time.

The display modules further include connection mechanisms configured to detachably couple adjacent modules together in a variety of configurations. The connection mechanisms may permit axial and/or lateral attachment, support repeatable positional alignment, constrain relative rotation between connected modules, and enable tool-free separation by a child. Through these mechanisms, multiple modules may be connected in linear or other arrangements to form words, numbers, equations, symbols, or patterns. Each movable character carrier remains independently operable even when multiple modules are connected, allowing users to modify individual characters without disturbing adjacent modules.

In certain embodiments, the housing and character carrier cooperate to provide tactile and auditory feedback during movement of the carrier. For example, detent or indexing features may be provided that generate resistance and produce an audible clicking sound as the character carrier is moved between discrete positions. Such feedback enhances user engagement, confirms character alignment, and supports intuitive operation, particularly for child users. In further embodiments, the housing may be at least partially translucent, allowing partial visibility of adjacent characters on the carrier to provide a visual directional cue during rotation.

The invention further encompasses a learning system that integrates the modular educational device with an external computing device, such as a smartphone, tablet, or other computing apparatus. The external computing device may include a camera and a processor configured to capture image data representing characters displayed through the viewing windows of the connected modules. Using computer vision-based recognition techniques, the external computing device may identify the displayed characters, evaluate the character sequence, and generate instructional output. Such output may include visual or audio feedback, pronunciation guidance, spelling validation, numerical evaluation, progress tracking, or game-based interactions.

Importantly, the modular display modules may be free of embedded electronic sensors, processors, or power sources, with all electronic processing being performed by the external computing device. This separation of physical and digital components reduces manufacturing complexity and cost, improves durability, and allows the device to function as both a standalone, screen-free learning tool and as part of a digitally enhanced learning system. In alternative embodiments, the modular units may optionally include markings, sensors, or powered components to extend functionality without departing from the core inventive concept.

The invention also includes methods of use for facilitating learning. Such methods may involve arranging modular display units, moving character carriers to present selected characters, capturing image data of the displayed characters, recognizing the characters using computer vision techniques, and generating instructional feedback. These methods support structured learning workflows for literacy, numeracy, phonics, pattern recognition, and creative exploration.

Through its combination of movable character carriers, controlled visual presentation, modular physical connectivity, tactile and auditory engagement, and optional digital interaction, the present invention provides a flexible and scalable educational solution that overcomes limitations of conventional learning tools. The invention enables intuitive character selection, rapid reconfiguration, and multi-sensory engagement while supporting a wide range of educational applications across home, classroom, and therapeutic environments.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE ACCOMPANYING DRAWINGS

The accompanying drawings, which are incorporated in and form a part of the specification, illustrate exemplary embodiments of the present invention and, together with the description, serve to explain the principles of the invention. The drawings are not intended to be limiting, and like reference numerals refer to like elements throughout.

The accompanying drawings illustrate exemplary embodiments of the present invention and are provided to explain the structure, operation, and use of the modular educational device. The drawings are illustrative and not intended to limit the scope of the invention.

FIG. 1A is a perspective view of a single modular unit, illustrating a housing, a rotatable character carrier, a viewing window, and a connection mechanism.

FIG. 1B is an alternate perspective view of the single modular unit of FIG. 1A, showing additional structural details of the housing and the character carrier.

FIG. 2A is an exploded perspective view of the single modular unit, illustrating separation of the housing and the character carrier prior to assembly.

FIG. 2B is an alternate exploded perspective view of the single modular unit, further illustrating internal retention features and an internal cavity of the housing.

FIG. 3A is a front view of the single modular unit, showing alignment of an imprinted character within the viewing window.

FIG. 3B is a front exploded view of the single modular unit, illustrating the relative positioning of the housing, the viewing window, and the character carrier.

FIG. 4A is a left-hand side view of the single modular unit, illustrating side-profile features of the housing, the character carrier, and the connection mechanism.

FIG. 4B is a right-hand side view of the single modular unit, illustrating structural symmetry and engagement features of the housing and the character carrier.

FIG. 5 is a perspective view of multiple modular units connected together, demonstrating formation of a character sequence using adjacent modular units.

FIG. 6 illustrates user interaction with multiple connected modular units, showing manual rotation of the character carriers.

FIG. 7 illustrates character carriers having different sets of imprinted characters, demonstrating interchangeability and customization of character content.

FIG. 8 illustrates use of multiple modular units with an external computing device, such as a smartphone or tablet, for capturing and recognizing displayed characters.

### DETAILED DESCRIPTION OF THE INVENTION

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

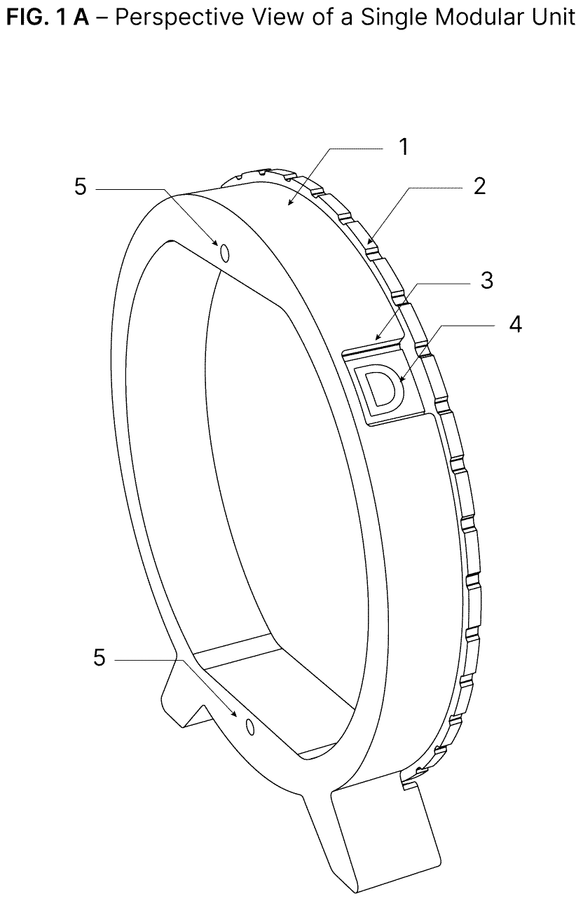

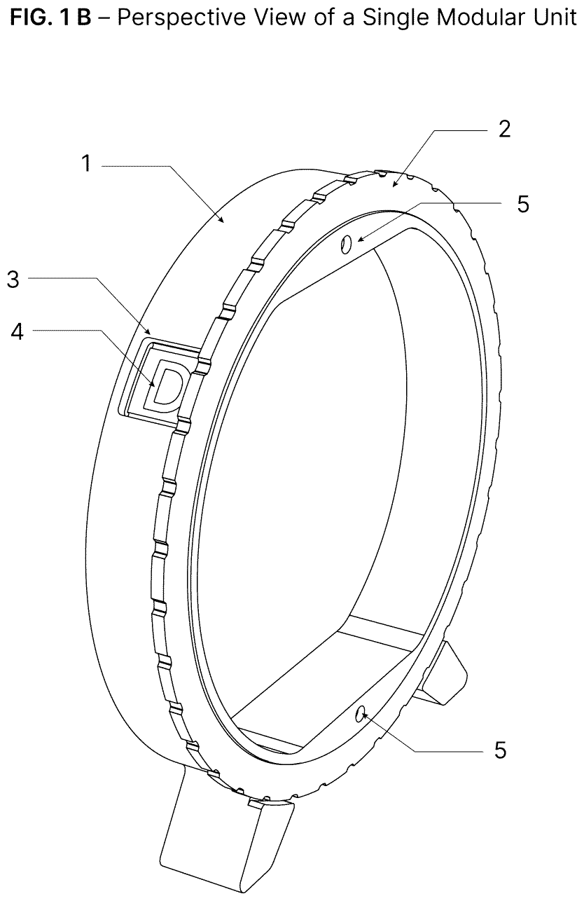

Referring now to FIG. 1A, a perspective view of a single modular unit of the modular educational device is illustrated in accordance with an exemplary embodiment of the present invention. FIG. 1A depicts the overall external structure and the primary functional components of the modular unit in an assembled state.

As shown, the modular unit includes a housing (1) that defines the main structural body of the unit. The housing (1) is preferably formed as a generally annular structure having a continuous outer peripheral surface and an inner opening. The housing may be manufactured from a rigid, durable, and child-safe material such as molded plastic or polymer. In certain embodiments, the housing (1) may be fully opaque or at least partially translucent, allowing limited visibility of adjacent characters on the carrier to provide a directional or anticipatory visual cue during operation.

Positioned concentrically within the housing (1) is a carrier (2), also referred to as a movable or rotatable character carrier. The carrier (2) is configured for rotational movement relative to the housing while being axially retained therein. As illustrated in FIG. 1A, an outer peripheral portion of the carrier (2) extends outwardly from the housing (1), enabling direct manual engagement by a user. The outer edge of the carrier (2) may include segmented protrusions, ridges, or textured features to facilitate grip and controlled rotation.

The housing (1) includes a viewing window (3) formed through a portion of the outer wall of the housing. The viewing window (3) is dimensioned and positioned to expose only a limited region of the carrier (2). Disposed on the carrier (2), and visible through the viewing window (3), are imprinted characters (4). In FIG. 1A, a single character is shown aligned with the viewing window, illustrating how one character at a time is selectively displayed. Rotation of the carrier (2) causes different characters (4) arranged circumferentially around the carrier to sequentially align with the viewing window (3).

The configuration shown in FIG. 1A ensures that only one character is clearly visible per modular unit at any given time, thereby reducing visual clutter and supporting focused learning. The characters (4) may include letters, numbers, symbols, or pictorial representations depending on the intended educational application.

Also visible in FIG. 1A is a connection mechanism (5) integrated into the housing (1). The connection mechanism (5) may be formed as apertures, recesses, protrusions, magnetic elements, or other engagement features configured to detachably couple the modular unit with one or more adjacent modular units. The placement of the connection mechanism (5) on the housing (1) allows multiple modular units to be aligned and connected in a stable and repeatable manner.

Additionally, FIG. 1A illustrates a base or support portion formed as part of the housing (1). This base portion extends outwardly from a lower region of the housing and is configured to support the modular unit in an upright position when placed on a flat surface. When multiple modular units are connected together, corresponding base portions cooperate to provide stability to the assembled structure.

In certain embodiments, interaction between the carrier (2) and internal features of the housing (1) may include detent or ratcheting structures (not explicitly visible in FIG. 1A) that provide tactile resistance and may generate an audible clicking sound during rotation. Such feedback enhances user engagement and assists in discrete alignment of characters with the viewing window (3).

Accordingly, FIG. 1A illustrates a compact, self-contained modular unit that integrates a movable character carrier, controlled visual display, and modular connectivity. This configuration forms a fundamental building block of the modular educational device, enabling independent character selection within each unit and cooperative interaction among multiple units when connected together.

Referring now to FIG. 1B, a perspective view of a single modular unit of the modular educational device is illustrated from an alternate angle relative to FIG. 1A. FIG. 1B provides additional detail regarding the external geometry of the modular unit and further illustrates the relationship between the housing (1) and the carrier (2) in an assembled state.

As shown in FIG. 1B, the housing (1) forms a generally annular body that surrounds and retains the carrier (2). The housing includes a continuous outer peripheral surface and an inner opening defining an internal cavity in which the carrier (2) is rotatably retained. The housing (1) may be formed as a single-piece structure or as multiple components assembled together, and may be manufactured from a rigid, child-safe material suitable for repeated handling. In certain embodiments, the housing (1) may be partially translucent, allowing limited visibility of adjacent characters on the carrier to provide visual guidance regarding the direction of rotation.

The carrier (2) is positioned concentrically within the housing (1) and is configured to rotate relative to the housing about a central axis. In FIG. 1B, the outer peripheral edge of the carrier (2) is clearly visible and extends slightly beyond the housing, enabling manual engagement by a user. The outer edge of the carrier (2) may include textured surfaces, ridges, or segmented protrusions that enhance grip and facilitate controlled rotation, particularly by children.

FIG. 1B further illustrates the viewing window (3) formed in the housing (1). Through the viewing window (3), an imprinted character (4) disposed on the carrier (2) is visible. This perspective emphasizes how the viewing window is recessed or framed within the housing to protect the character display while maintaining clear visibility. As the carrier (2) is rotated, successive characters align with the viewing window (3) for selective display.

The connection mechanism (5) is also visible in FIG. 1B and is integrated into the housing (1). The connection mechanism (5) may include apertures, recesses, or engagement features positioned to cooperate with corresponding connection mechanisms of adjacent modular units. The placement and symmetry of the connection mechanism (5) enable modular units to be detachably connected in a stable and aligned configuration.

Additionally, FIG. 1B shows the base or support portion extending from the housing (1). This base portion is configured to support the modular unit on a flat surface and to contribute to the stability of multiple connected modular units when assembled together. The base portion may be integrally formed with the housing or attached thereto as a separate component.

From the perspective shown in FIG. 1B, the overall thickness and profile of the modular unit are more apparent, illustrating a compact and balanced design that allows multiple units to be positioned closely adjacent to one another when connected. This configuration supports uniform spacing of viewing windows across connected units, improving readability and facilitating interaction by external computing devices when used in conjunction with digital recognition systems.

In certain embodiments, the interaction between the carrier (2) and internal features of the housing (1) may include indexing or detent structures that provide tactile resistance and produce an audible clicking sound during rotation. Although not explicitly shown in FIG. 1B, such features may be incorporated to provide positive feedback indicating alignment of characters with the viewing window (3).

Accordingly, FIG. 1B complements FIG. 1A by providing an alternate perspective that highlights the external form, ergonomic features, and modular connectivity of the single modular unit, further illustrating how the housing (1) and carrier (2) cooperate to enable intuitive character selection and modular assembly.

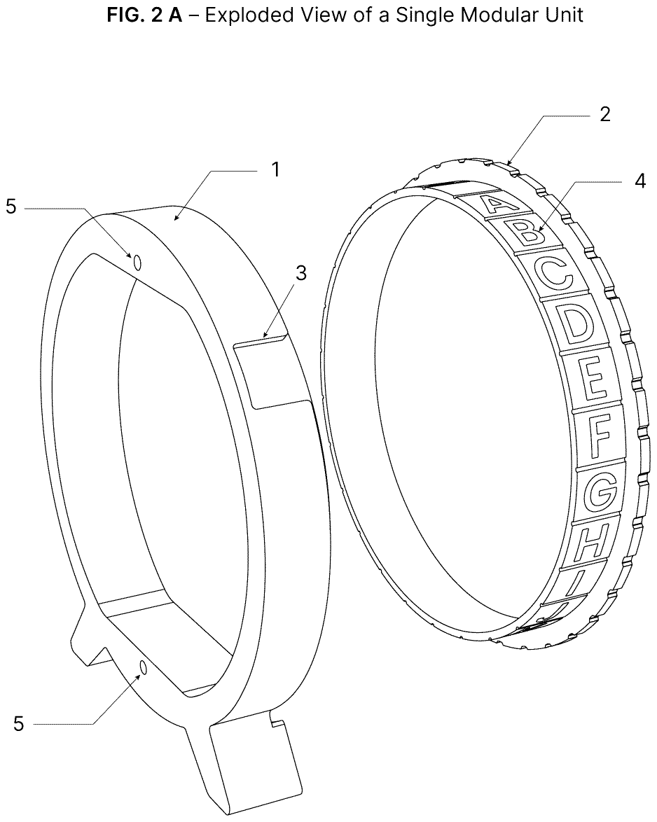

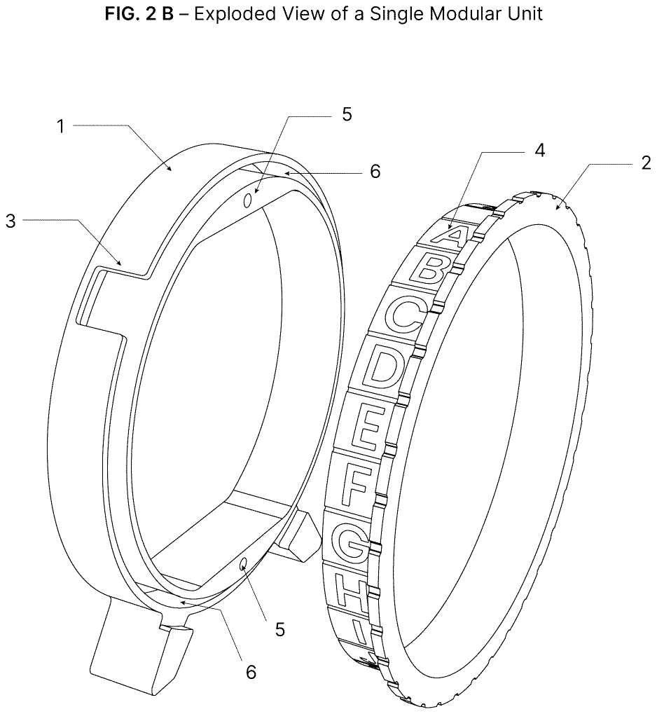

Referring now to FIG. 2A, an exploded perspective view of a single modular unit of the modular educational device is illustrated in accordance with an exemplary embodiment of the present invention. FIG. 2A is provided to clearly show the individual components of the modular unit and the manner in which those components are assembled to form a functional unit.

As shown in FIG. 2A, the modular unit generally comprises a housing (1) and a carrier (2), which are shown separated from one another for clarity. The housing (1) forms the primary structural body of the modular unit and is configured to receive and retain the carrier (2) therein. The housing (1) defines an internal opening and includes structural features that form an internal cavity sized to accommodate the carrier (2) while allowing rotational movement of the carrier relative to the housing.

The carrier (2) is illustrated as a generally annular or ring-shaped component configured to be positioned concentrically within the housing (1). Disposed circumferentially around an outer surface of the carrier (2) are a plurality of imprinted characters (4). In the illustrated embodiment, the characters are alphabetic letters arranged in sequence; however, it is understood that the characters may alternatively include numbers, symbols, images, or combinations thereof depending on the intended educational application.

FIG. 2A illustrates the relative orientation of the carrier (2) with respect to the housing (1) prior to assembly. During assembly, the carrier (2) is aligned with the internal cavity of the housing (1) and inserted axially into the housing. The housing (1) may include internal retention features such as inwardly extending lips, shoulders, grooves, or flanges that cooperate with corresponding surfaces of the carrier (2) to axially retain the carrier once inserted. These retention features prevent unintended removal of the carrier (2) during normal use while permitting smooth rotational movement.

Also visible in FIG. 2A is the viewing window (3) formed in the housing (1). The viewing window (3) is positioned such that, when the carrier (2) is installed within the housing, individual imprinted characters (4) on the carrier may be selectively aligned with and displayed through the viewing window. The exploded view clearly illustrates how the carrier (2) and viewing window (3) cooperate to enable controlled display of a single character at a time.

The connection mechanism (5) is further illustrated in FIG. 2A as part of the housing (1). The connection mechanism (5) may include apertures, recesses, protrusions, or other engagement features configured to detachably connect the modular unit to adjacent modular units. The exploded view highlights that the connection mechanism (5) is structurally independent of the carrier (2), allowing modular connectivity without interfering with the rotational function of the carrier.

Additionally, FIG. 2A illustrates a base or support portion formed on the housing (1). This base portion is configured to support the modular unit on a surface and to cooperate with base portions of adjacent modular units when multiple units are connected together.

In certain embodiments, the carrier (2) and housing (1) may include complementary indexing or detent features (not explicitly shown in FIG. 2A) that provide tactile feedback and may generate an audible clicking sound as the carrier is rotated. Such features assist in discrete positioning of characters relative to the viewing window (3) and enhance user engagement.

Accordingly, FIG. 2A illustrates the fundamental components and assembly relationship of a single modular unit, emphasizing the simplicity, durability, and manufacturability of the design. The exploded view further demonstrates how the housing (1) and carrier (2) cooperate to enable selective character display, modular connectivity, and intuitive user interaction.

Referring now to FIG. 2B, an alternate exploded perspective view of a single modular unit of the modular educational device is illustrated. FIG. 2B complements FIG. 2A by presenting the components from a different orientation, thereby providing enhanced visibility of the internal structural features of the housing (1) and the cooperative relationship between the housing and the carrier (2).

As shown in FIG. 2B, the housing (1) defines a generally annular body having an internal opening that forms an internal cavity (6). The internal cavity (6) is dimensioned to receive the carrier (2) and is configured to allow controlled rotational movement of the carrier once assembled. The internal surfaces of the housing (1) may include smooth bearing surfaces, guide rails, or contoured profiles to reduce friction and ensure consistent rotation of the carrier (2) during use.

FIG. 2B further illustrates internal retention features formed as part of the housing (1). Such retention features may include inwardly extending lips, shoulders, grooves, or circumferential flanges positioned along the internal cavity (6). These features are configured to axially retain the carrier (2) once inserted, preventing removal of the carrier while permitting rotational movement. In some embodiments, the housing (1) may be elastically deformable during assembly to allow snap-fit engagement with the carrier (2), after which the housing returns to its original shape to securely capture the carrier.

The carrier (2) is illustrated in FIG. 2B as a generally annular component sized to fit concentrically within the internal cavity (6) of the housing (1). The carrier (2) includes a plurality of imprinted characters (4) disposed circumferentially around its outer surface. Each character is positioned at a predetermined angular spacing, corresponding to discrete display positions when aligned with the viewing window of the housing.

From the perspective of FIG. 2B, the carrier (2) may further be seen to include peripheral features along its outer edge, such as ridges, teeth, or segmented protrusions. These features serve to facilitate manual rotation by a user and may also cooperate with complementary features of the housing (1) to provide indexing or detent functionality. In certain embodiments, engagement between these features produces tactile resistance and may generate an audible clicking sound as the carrier is rotated, providing feedback to the user and assisting in precise alignment of characters.

FIG. 2B also more clearly illustrates the viewing window (3) formed in the housing (1). The relative positioning of the viewing window (3) and the carrier (2) demonstrates how only a limited region of the carrier is visible at any given time, such that a single imprinted character (4) is displayed. This configuration supports focused learning by minimizing visual clutter and enabling selective character presentation.

Additionally, FIG. 2B shows portions of the connection mechanism (5) integrated into the housing (1). The connection mechanism (5) may include apertures, recesses, or engagement structures positioned to align with corresponding features of adjacent modular units. The exploded orientation emphasizes that the connection mechanism (5) is structurally independent of the internal cavity (6) and does not interfere with the rotational operation of the carrier (2).

In certain embodiments, the housing (1) may further include alignment features or stops that cooperate with the carrier (2) to define repeatable rotational positions corresponding to the characters (4). Such features ensure consistent alignment of each character with the viewing window (3) across repeated uses and between different modular units.

Accordingly, FIG. 2B provides a detailed illustration of the internal construction and assembly relationship of the modular unit, highlighting how the housing (1), internal cavity (6), and carrier (2) cooperate to provide secure retention, smooth rotation, precise character alignment, and durable operation. This figure reinforces the manufacturability and robustness of the modular unit while supporting the functional advantages described throughout the specification.

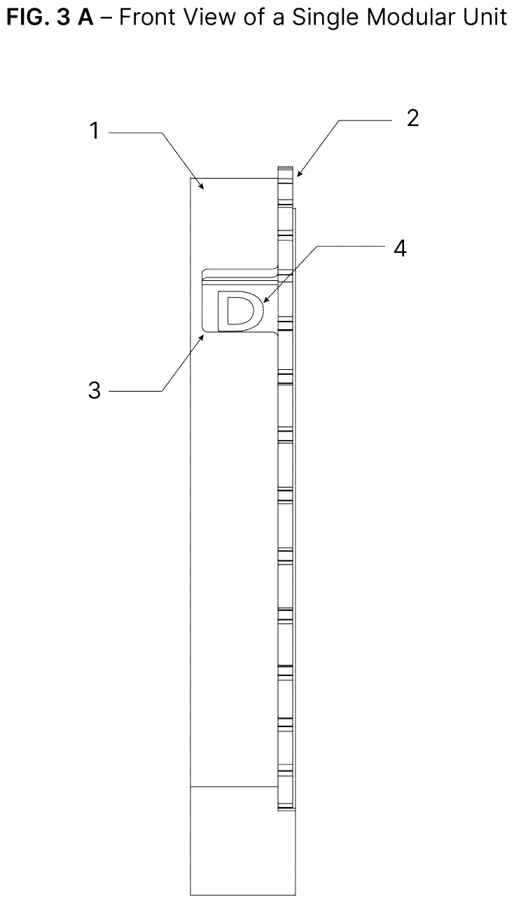

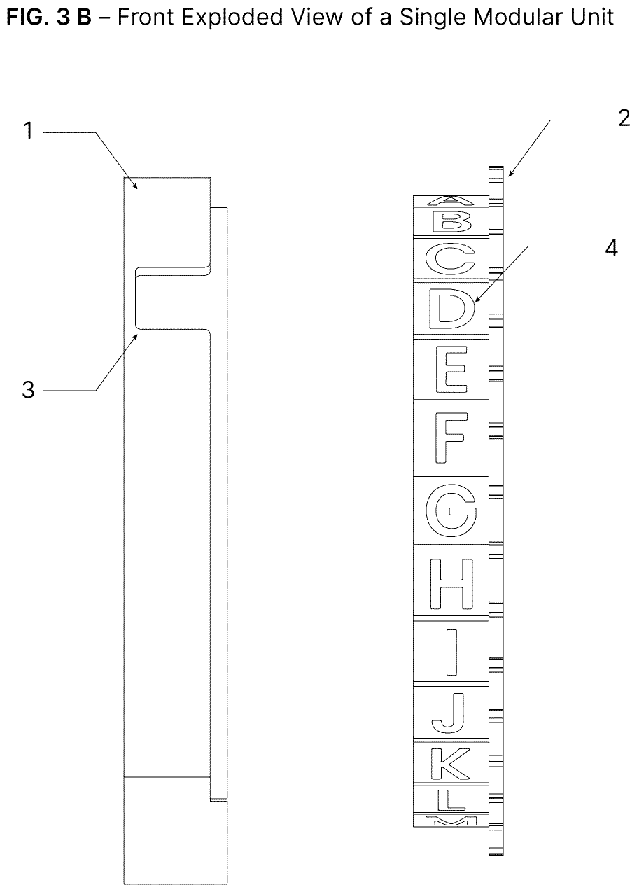

Referring now to FIG. 3A, a front view of a single modular unit of the modular educational device is illustrated in accordance with an exemplary embodiment of the present invention. FIG. 3A is provided to clearly depict the frontal presentation of the modular unit and the cooperative relationship between the housing (1), the carrier (2), and the viewing window (3) during use.

As shown in FIG. 3A, the housing (1) defines an outer frame of the modular unit and includes a generally annular configuration that surrounds and retains the carrier (2). The housing (1) may be formed from a rigid, child-safe material and is shaped to provide a stable and ergonomic exterior profile. The housing (1) further includes a base or support portion that allows the modular unit to stand upright on a flat surface.

Positioned within the housing (1) is the carrier (2), which is configured to rotate relative to the housing. The carrier (2) is concentrically arranged within the housing and is axially retained therein, such that rotational movement is permitted while axial displacement is constrained. From the front view shown in FIG. 3A, the outer peripheral edge of the carrier (2) is visible and accessible, allowing a user to manually rotate the carrier.

Formed in the housing (1) and clearly visible in FIG. 3A is the viewing window (3). The viewing window (3) is centrally located along a front-facing portion of the housing and is dimensioned to expose only a limited region of the carrier (2). Aligned within the viewing window (3) is one of the imprinted characters (4) disposed on the carrier (2). In the illustrated embodiment, a single character is shown centered within the viewing window, demonstrating the manner in which characters are selectively displayed.

FIG. 3A illustrates that only one character is visible through the viewing window (3) at any given time, even though multiple characters are present on the carrier (2). Rotation of the carrier (2) causes different characters to sequentially align with the viewing window, enabling controlled selection and display of characters. This configuration minimizes visual distraction and supports focused learning by presenting one character per modular unit.

The front view of FIG. 3A further emphasizes the symmetry and compact form factor of the modular unit. The uniform shape and consistent placement of the viewing window (3) facilitate alignment when multiple modular units are connected together, as described with reference to other figures. Such alignment improves readability of displayed characters and supports use of the modular units with an external computing device for image-based character recognition.

In certain embodiments, the carrier (2) and housing (1) may include internal indexing or detent features (not visible in FIG. 3A) that provide tactile feedback and may generate an audible clicking sound as the carrier is rotated. These features assist in positioning the characters (4) accurately within the viewing window (3) and enhance user engagement.

Accordingly, FIG. 3A illustrates the operational state of a single modular unit during use, highlighting the frontal presentation of the displayed character, the accessibility of the carrier for rotation, and the clear visual interface provided by the viewing window. This figure demonstrates how the modular unit functions as a focused, intuitive, and self-contained character display element within the broader modular educational device.

Referring now to FIG. 3B, a front exploded view of a single modular unit of the modular educational device is illustrated in accordance with an exemplary embodiment of the present invention. FIG. 3B is provided to further clarify the structural relationship between the housing (1) and the carrier (2) and to illustrate the manner in which these components are aligned and assembled to enable selective character display.

As shown in FIG. 3B, the housing (1) is illustrated as a generally annular body having an opening that defines an internal cavity (6). The housing (1) includes a viewing window (3) formed through a front-facing portion thereof. The viewing window (3) is positioned such that, when the modular unit is assembled, it exposes only a limited region of the carrier (2) for display of a single character at a time.

The carrier (2) is shown in FIG. 3B as a separate component positioned forward of the housing (1) prior to assembly. The carrier (2) is configured to be received within the internal cavity (6) of the housing (1) and to be retained therein for rotational movement. Disposed circumferentially around an outer surface of the carrier (2) are a plurality of imprinted characters (4). The characters (4) are arranged at predetermined angular intervals corresponding to discrete display positions when aligned with the viewing window (3).

FIG. 3B illustrates the alignment of the carrier (2) relative to the viewing window (3) prior to assembly, showing how the characters (4) are oriented to face outward toward the viewing window. During assembly, the carrier (2) is inserted into the internal cavity (6) of the housing (1) such that the imprinted characters (4) are positioned behind the viewing window (3). Once assembled, rotation of the carrier (2) causes successive characters to align with and be visible through the viewing window (3).

The exploded view of FIG. 3B further highlights the simplicity of the assembly process. The housing (1) may include internal retention features, such as inwardly extending lips, shoulders, grooves, or snap-fit elements, which cooperate with corresponding features of the carrier (2) to axially retain the carrier while allowing free rotational movement. These retention features are not explicitly labeled in FIG. 3B but are understood to be present within the internal cavity (6).

Additionally, FIG. 3B illustrates portions of the connection mechanism (5) integrated into the housing (1). The connection mechanism (5) is configured to detachably couple the modular unit to adjacent modular units and is positioned so as not to interfere with the internal cavity (6) or the rotational movement of the carrier (2).

In certain embodiments, the carrier (2) may include indexing or detent features that cooperate with complementary structures of the housing (1) to define repeatable rotational positions corresponding to the imprinted characters (4). Such features may provide tactile resistance and generate an audible clicking sound during rotation, assisting in precise alignment of the characters with the viewing window (3).

Accordingly, FIG. 3B provides a clear illustration of the internal construction and assembly relationship of the modular unit from a front-facing perspective. This figure reinforces how the housing (1), internal cavity (6), viewing window (3), and carrier (2) cooperate to provide controlled character display, secure retention, and intuitive operation within the modular educational device.

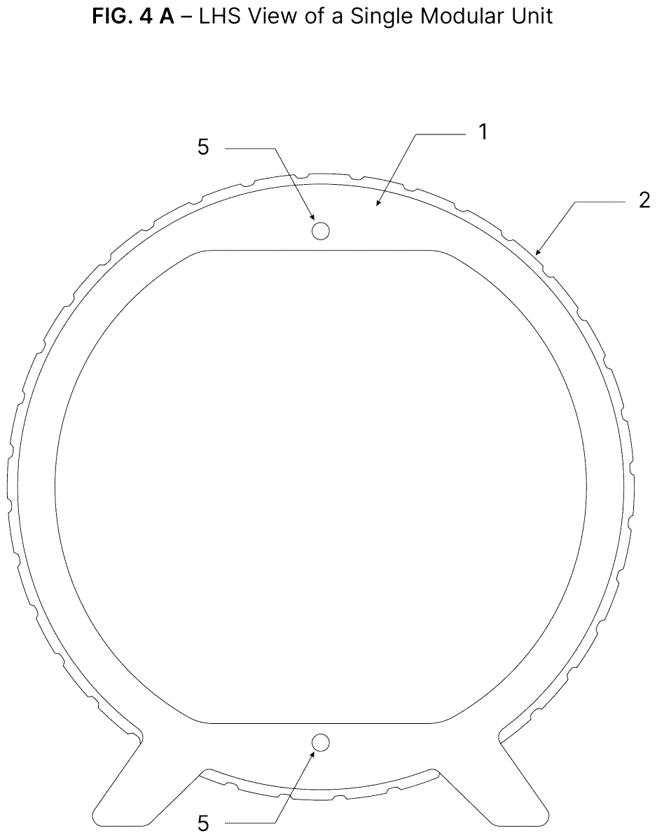

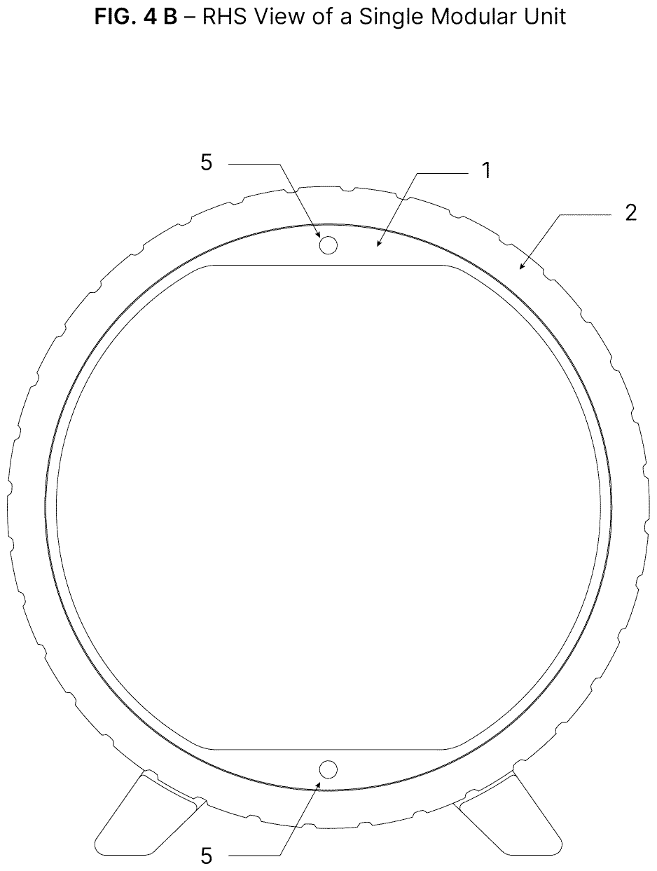

Referring now to FIG. 4A, a left-hand side view of a single modular unit of the modular educational device is illustrated in accordance with an exemplary embodiment of the present invention. FIG. 4A is provided to show the side profile of the modular unit and to further clarify the spatial relationship between the housing (1), the carrier (2), and the connection mechanism (5) when viewed from a lateral direction.

As shown in FIG. 4A, the housing (1) defines a generally annular body that encloses and supports the carrier (2). From the side view, the thickness of the housing (1) and its outer peripheral contour are clearly visible, illustrating a compact and robust construction suitable for repeated handling by a user, particularly a child. The housing (1) may include smooth, rounded external surfaces to enhance ergonomics and reduce the risk of injury during use.

The carrier (2) is positioned within the housing (1) and is partially exposed along an outer peripheral edge thereof. FIG. 4A illustrates how a portion of the carrier (2) extends beyond the housing (1), enabling direct manual engagement for rotation. This exposed portion may include ridges, teeth, or textured grip features that facilitate controlled rotation of the carrier by a user. The side view further demonstrates that the carrier (2) is axially retained within the housing (1), such that it remains securely positioned during rotation.

FIG. 4A also illustrates the relative vertical positioning of the viewing window (3) (not directly visible from the side) with respect to the carrier (2). The side profile indicates that the viewing window is located in a front-facing region of the housing (1), while the carrier (2) rotates behind the front wall of the housing to selectively present characters through the viewing window during use.

The connection mechanism (5) is clearly shown in FIG. 4A as being integrated into a side region of the housing (1). In the illustrated embodiment, the connection mechanism (5) may be formed as an aperture, recess, protrusion, magnetic element, or engagement feature configured to cooperate with a complementary connection mechanism of an adjacent modular unit. The side view of FIG. 4A highlights how the connection mechanism (5) is positioned to allow lateral attachment of adjacent modular units while maintaining proper alignment and spacing.

Additionally, FIG. 4A shows a base or support portion extending downwardly from the housing (1). This base portion is configured to support the modular unit on a flat surface and to contribute to the stability of the unit when standing alone or when connected with other modular units. The base portion may include a flat lower surface or a widened footprint to prevent tipping.

In certain embodiments, the housing (1) and carrier (2) may include internal detent or indexing features (not visible in FIG. 4A) that provide tactile resistance and audible feedback during rotation of the carrier. While such features are internal, FIG. 4A illustrates the external geometry that accommodates these functional elements without increasing the overall size of the modular unit.

Accordingly, FIG. 4A illustrates the side-profile characteristics of the modular unit, emphasizing the ergonomic design, accessibility of the carrier for rotation, and integration of the connection mechanism. This figure demonstrates how the modular unit is configured for stable placement, easy manipulation, and seamless lateral connection with adjacent modular units, further supporting the modular and user-friendly nature of the educational device.

Referring now to FIG. 4B, a right-hand side view of a single modular unit of the modular educational device is illustrated in accordance with an exemplary embodiment of the present invention. FIG. 4B complements the left-hand side view of FIG. 4A and is provided to further illustrate the lateral profile, structural symmetry, and connection features of the modular unit when viewed from an opposite side.

As shown in FIG. 4B, the housing (1) forms a generally annular body that encloses and retains the carrier (2). The outer side surface of the housing (1) is illustrated as smooth and contoured, contributing to an ergonomic shape suitable for handling by a user. In certain embodiments, the housing (1) may include rounded edges and softened corners to enhance child safety and comfort during use.

The carrier (2) is positioned concentrically within the housing (1) and is partially exposed along its outer peripheral edge. FIG. 4B illustrates that the exposed portion of the carrier (2) is accessible from either lateral side of the modular unit, allowing the user to rotate the carrier from different angles. The outer edge of the carrier (2) may include grip-enhancing features such as ridges or textured surfaces to assist in manual rotation.

FIG. 4B further illustrates that the connection mechanism (5) is disposed on the right-hand side of the housing (1) in a manner corresponding to the connection mechanism shown on the left-hand side in FIG. 4A. The symmetrical placement of the connection mechanism (5) on opposing sides of the housing (1) allows modular units to be connected in either orientation and supports consistent alignment between adjacent units. The connection mechanism (5) may include an aperture, recess, protrusion, magnetic element, or other engagement structure configured to cooperate with a complementary connection mechanism of an adjacent modular unit.

From the side view of FIG. 4B, the relative depth and thickness of the housing (1) are clearly visible, illustrating a balanced design that supports durability without excessive bulk. The side profile further shows how the carrier (2) is recessed within the housing (1) while remaining accessible for rotation, thereby protecting the carrier from accidental dislodgement during use.

The base or support portion extending from the housing (1) is also visible in FIG. 4B. This base portion may be integrally formed with the housing and provides a stable support surface when the modular unit is placed on a flat surface. When multiple modular units are connected together, corresponding base portions cooperate to form a stable, continuous support structure.

In certain embodiments, FIG. 4B also reflects that the housing (1) may be configured to constrain relative rotation between connected modular units, either through the shape of the connection mechanism (5) or through internal alignment features. Such constraints ensure that viewing windows of adjacent units remain aligned in a common orientation during use.

Accordingly, FIG. 4B illustrates the opposite side profile of the modular unit and reinforces the symmetrical, ergonomic, and modular design of the housing (1), the accessibility of the carrier (2) for rotation, and the placement of the connection mechanism (5). This figure demonstrates how the modular unit is configured for intuitive assembly, stable connection, and consistent alignment when used alone or as part of a multi-unit educational assembly.

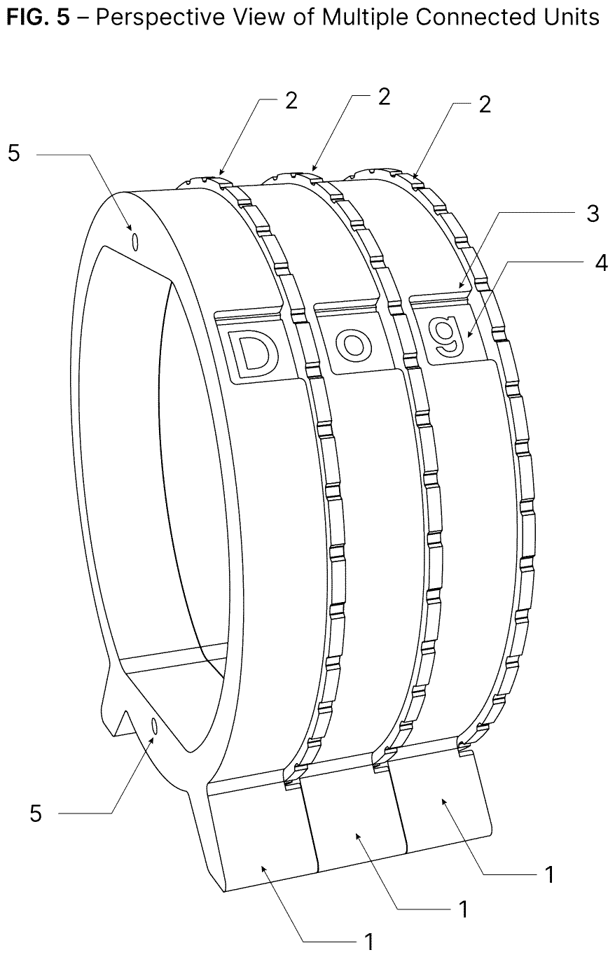

Referring now to FIG. 5, a perspective view of a plurality of modular units connected together is illustrated in accordance with an exemplary embodiment of the present invention. FIG. 5 demonstrates the assembled configuration of multiple modular units and illustrates how individual units cooperate to form a composite educational display for presenting a sequence of characters.

As shown in FIG. 5, multiple modular units are detachably coupled side-by-side via their respective connection mechanisms (5). Each modular unit includes a housing (1) that rotatably retains a corresponding carrier (2). The connection mechanisms (5) maintain the modular units in a stable and aligned arrangement while permitting tool-free assembly and disassembly by a user, including a child.

Each housing (1) includes a viewing window (3) through which a single imprinted character (4) on the corresponding carrier (2) is visible. In the illustrated embodiment, the modular units are arranged in a linear sequence such that the viewing windows (3) face a common direction and are evenly spaced. The characters displayed through the respective viewing windows collectively form a recognizable word or character sequence, thereby illustrating one exemplary use of the invention for literacy or spelling activities.

FIG. 5 highlights that each carrier (2) is independently rotatable relative to its housing (1) even when multiple modular units are connected together. This allows a user to change any individual character in the sequence by rotating the corresponding carrier without disturbing adjacent units. Such independent operation encourages experimentation and trial-and-error learning while preserving the overall arrangement of the modular units.

The connection mechanisms (5) illustrated in FIG. 5 may be configured to provide repeatable positional alignment between adjacent housings (1), ensuring that the modular units remain properly oriented during use. In certain embodiments, the connection mechanisms may constrain relative rotation between adjacent units so that the viewing windows (3) remain aligned in a common plane, thereby improving readability and visual consistency across the assembled sequence.

FIG. 5 further illustrates that each housing (1) may include a base or support portion extending downwardly therefrom. When multiple modular units are connected together, these base portions cooperate to form a continuous support structure that allows the assembled units to stand upright on a flat surface, such as a table or desk, without additional support. This freestanding capability enables hands-free viewing and interaction during learning activities.

In some embodiments, the arrangement shown in FIG. 5 is particularly well suited for use with an external computing device (7), such as a smartphone or tablet, positioned to capture an image of the displayed character sequence. The aligned viewing windows and consistent spacing between characters facilitate accurate image capture and recognition when computer vision-based processing is employed to identify the displayed characters and provide instructional feedback.

Accordingly, FIG. 5 illustrates the cooperative interaction of multiple modular units when connected together, emphasizing the modularity, scalability, and independent operability of the invention. This figure demonstrates how the modular educational device may be configured to display multi-character sequences in a stable, readable, and reconfigurable manner, supporting a wide range of educational applications including spelling, word formation, numeracy, and pattern recognition.

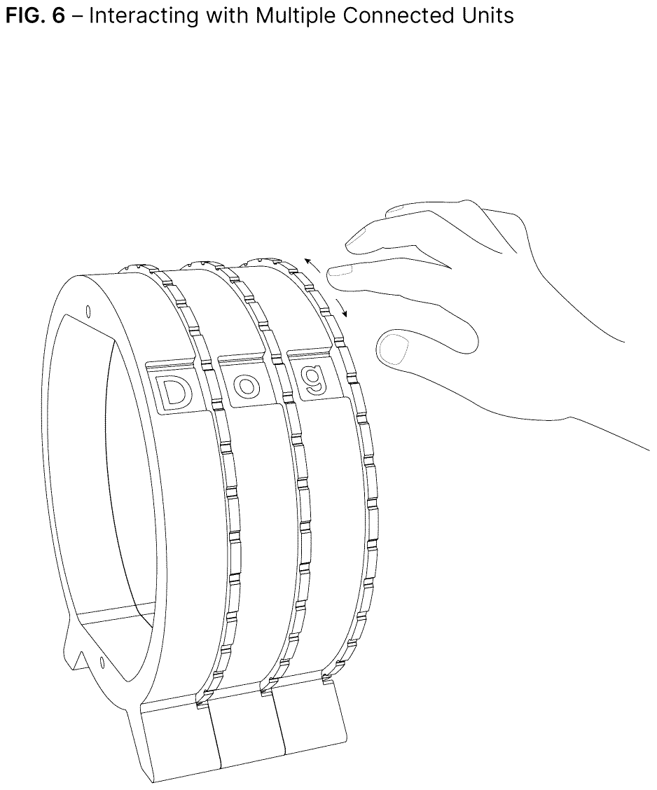

Referring now to FIG. 6, a perspective view illustrating user interaction with a plurality of connected modular units of the modular educational device is shown in accordance with an exemplary embodiment of the present invention. FIG. 6 is provided to demonstrate the manner in which a user operates the modular units during normal use and to highlight the tactile and interactive nature of the invention.

As illustrated in FIG. 6, multiple modular units are detachably connected together via their respective connection mechanisms (5) to form an assembled sequence. Each modular unit includes a housing (1) that rotatably retains a carrier (2), with one imprinted character (4) from each carrier being visible through a corresponding viewing window (3). The modular units are arranged such that the viewing windows are aligned in a common orientation for ease of viewing.

FIG. 6 illustrates a user manually engaging one or more of the carriers (2) using a hand or fingers to rotate the carriers relative to the housings (1). The exposed outer peripheral edges of the carriers (2) allow the user to selectively rotate each carrier independently, even while the modular units remain connected together. This independent rotation enables rapid modification of individual characters within the displayed sequence without requiring disassembly of the modular units.

The figure emphasizes the tactile feedback provided during rotation of the carriers (2). In certain embodiments, interaction between the carriers (2) and internal features of the housings (1) may include detent or ratcheting mechanisms that create resistance and produce an audible clicking sound as the carriers are rotated. Such tactile and auditory feedback assists the user in positioning the carriers accurately and enhances engagement, particularly for child users.

FIG. 6 further demonstrates that the modular educational device is designed for intuitive, tool-free operation. The user may easily grasp and rotate any carrier (2) while the connection mechanisms (5) maintain the stability and alignment of the connected modular units. The base portions of the housings (1), when present, cooperate to support the assembled units on a surface during interaction.

In educational use, FIG. 6 illustrates how a learner may experiment with different character combinations by rotating one or more carriers (2) while observing changes in the displayed characters (4). This hands-on interaction encourages active learning, trial-and-error exploration, and cognitive engagement, supporting skill development in literacy, numeracy, and pattern recognition.

Accordingly, FIG. 6 illustrates the interactive use of the modular educational device during character selection and modification, highlighting the ergonomic design, independent operability of each modular unit, and the tactile feedback mechanisms that contribute to an engaging and user-friendly learning experience.

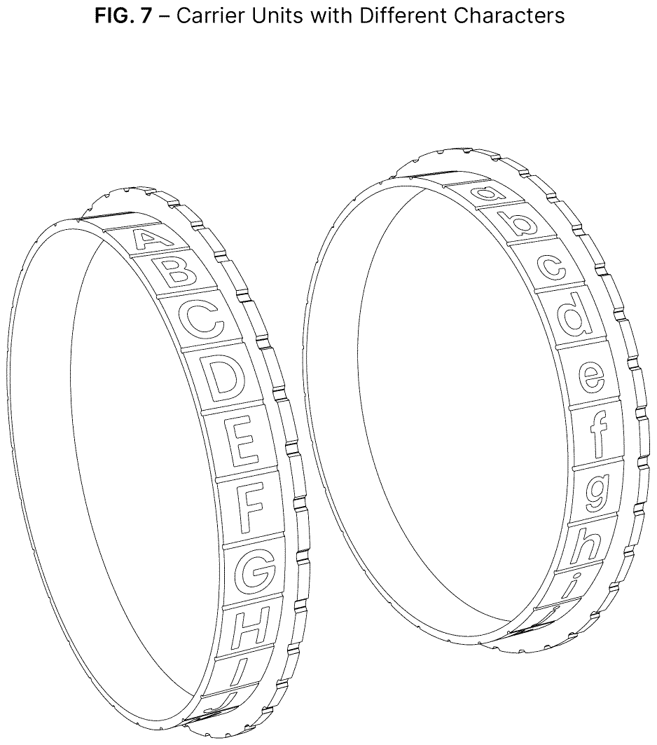

Referring now to FIG. 7, a perspective view illustrating multiple carriers (2) of the modular educational device is shown in accordance with an exemplary embodiment of the present invention. FIG. 7 is provided to demonstrate that the invention supports carriers having different sets of imprinted characters (4), thereby highlighting the customizable and adaptable nature of the modular educational device.

As illustrated in FIG. 7, a plurality of carriers (2) are shown separately from the housings. Each carrier (2) is configured as a movable character carrier, such as a rotatable ring, and is sized to be received within a corresponding housing (1) of a modular unit. The carriers (2) may be interchangeable with one another, allowing different character sets to be used with the same housing structure.

Each carrier (2) includes a plurality of imprinted characters (4) disposed circumferentially around an outer surface thereof. In the illustrated embodiment, different carriers are shown with different character sets. For example, one carrier may include uppercase alphabetic letters, another may include lowercase letters, another may include numerical characters, and another may include symbols, punctuation marks, or pictorial representations. The characters (4) may be printed, embossed, molded, engraved, or otherwise formed on the carrier (2).

FIG. 7 illustrates that the spacing and size of the characters (4) on each carrier (2) may be consistent across different character sets, thereby allowing the carriers to be interchangeably used within the same housings without affecting alignment with the viewing window (3). This consistency ensures that each character aligns accurately within the viewing window when the carrier is rotated.

The carriers (2) shown in FIG. 7 may further include peripheral grip features, ridges, or textured surfaces to facilitate manual rotation when installed within a housing. In certain embodiments, the carriers may also include indexing or detent features configured to cooperate with complementary features of the housing to define discrete rotational positions corresponding to the imprinted characters.

FIG. 7 demonstrates the modularity and scalability of the invention by illustrating that users may select and install carriers with specific character sets based on the intended learning activity. For example, a user may install carriers with alphabetic characters for spelling exercises, carriers with numbers and operators for mathematical learning, or carriers with symbols or images for creative or pattern-based activities.

Accordingly, FIG. 7 illustrates that the modular educational device is not limited to a single set of characters but is instead configurable with a variety of interchangeable carriers. This capability enables the device to be adapted for different educational objectives, age groups, languages, and subject matter while maintaining a consistent mechanical structure and user interface.

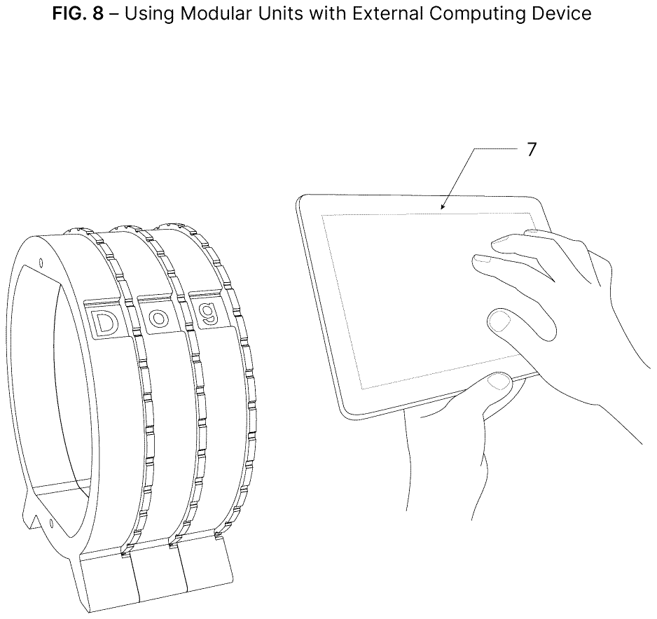

Referring now to FIG. 8, an exemplary use of the modular educational device in conjunction with an external computing device (7) is illustrated in accordance with an embodiment of the present invention. FIG. 8 demonstrates how the modular educational device may operate as part of a hybrid physical-digital learning system while remaining functional as a standalone mechanical device.

As shown in FIG. 8, a plurality of modular units are detachably connected together via their respective connection mechanisms (5) to form an assembled sequence. Each modular unit includes a housing (1) that rotatably retains a corresponding carrier (2), with one imprinted character (4) from each carrier being visible through a respective viewing window (3). The modular units are arranged such that the viewing windows are aligned in a common orientation and the displayed characters form a readable sequence.

Positioned in proximity to the assembled modular units is the external computing device (7), which may be a smartphone, tablet, laptop, or other computing apparatus equipped with a camera and a processor. The external computing device (7) is oriented such that its camera is capable of capturing image data representing the characters displayed through the viewing windows (3) of the modular units.

In the illustrated embodiment, the external computing device (7) executes software instructions that cause the processor to analyze the captured image data using computer vision-based recognition techniques. Such techniques may include detecting the presence and position of each modular unit, segmenting individual character regions corresponding to the viewing windows, and recognizing the imprinted characters displayed by the carriers (2). The recognized characters may then be processed to determine whether the displayed sequence matches a target word, number, symbol arrangement, or pattern.

Based on the recognition results, the external computing device (7) may generate instructional output, such as visual feedback, audio prompts, pronunciation guidance, spelling validation, numerical evaluation, scoring, or game-based responses. This feedback may be presented to the user via the display or speakers of the external computing device, thereby enhancing the educational experience through interactive and adaptive instruction.

Importantly, FIG. 8 illustrates that the modular units themselves may be free of embedded electronic sensors, processors, or power sources. All electronic processing, image capture, and feedback generation are performed by the external computing device (7). This configuration reduces manufacturing complexity and cost of the modular units while maintaining durability and suitability for use by children.

In certain alternative embodiments, the modular units may include optional visual markers, fiducial patterns, color coding, or alignment features to assist the external computing device (7) in accurately identifying and recognizing the displayed characters. Such features may be incorporated without altering the fundamental mechanical operation of the modular units.

Accordingly, FIG. 8 illustrates an integrated learning environment in which the modular educational device provides tactile, hands-on interaction through physical manipulation of character carriers, while the external computing device (7) provides digital analysis, feedback, and instructional guidance. This figure highlights the ability of the invention to bridge physical and digital learning modalities, offering enhanced interactivity, adaptability, and educational value without sacrificing simplicity or robustness of the physical device.

### Detailed Use Case Scenarios

The modular educational device with rotatable character rings may be used in a wide variety of educational, recreational, and developmental contexts. The invention is intentionally designed to be adaptable, scalable, and intuitive, enabling use by children, educators, caregivers, and learners of varying ages and skill levels. The following use case scenarios illustrate exemplary applications of the invention and are not intended to limit its scope.

### Early Literacy and Alphabet Learning

In a primary use case, the invention is employed to introduce alphabet recognition and letter familiarity to early learners. Each modular unit displays a single alphabetic character through its viewing window, allowing learners to focus on one letter at a time. A child may rotate the character ring of a unit to cycle through different letters until a desired letter is displayed.

Multiple modular units may be connected together to form short letter sequences. Educators or caregivers may prompt the learner to identify letters, match uppercase and lowercase letters using different units, or locate specific letters by rotating the rings. The tactile act of rotating the rings reinforces kinesthetic learning, while the visual isolation of individual characters reduces cognitive overload.

This use case is particularly effective for early childhood education environments, where learners benefit from hands-on interaction and repetition.

### Word Formation and Spelling Practice

In another common use case, the invention is used for spelling and word construction. Multiple modular units are connected in a linear arrangement, with each unit representing a single character position within a word. Learners may rotate each character ring independently to form a target word, such as a simple three-letter word during early stages or longer words as proficiency increases.

Educators may use the device for spelling drills, word-building exercises, or phonics-based instruction. Because characters can be changed by rotation rather than replacement of parts, learners can quickly experiment with letter combinations, encouraging trial-and-error learning and creative exploration.

This scenario also supports self-guided learning, as children can independently correct spelling by adjusting individual letters without disassembling the device.

### Phonics and Pronunciation Learning

The invention may be used to support phonics instruction, where learners associate letter combinations with sounds. Modular units may be configured with characters corresponding to phonemes, digraphs, or blends. By rotating rings to form different sound combinations, learners can visually and physically explore how sounds change when letters are rearranged.

In embodiments used with a digital application, the displayed characters may be recognized by a smartphone or tablet, which can provide audio pronunciation feedback. For example, when a learner forms a word or sound combination, the application may pronounce the word aloud, reinforce correct pronunciation, or prompt corrective guidance.

This use case is particularly valuable for language learners and early readers.

### Numeracy and Mathematical Learning

The invention is not limited to alphabetic characters and may also be used for numeracy and basic mathematics instruction. Modular units may include numbers, arithmetic operators, and symbols. Learners can connect units together to form number sequences, counting exercises, or simple mathematical expressions such as addition or subtraction problems.

For example, a learner may form an equation by arranging units to display “5+3=8” and verify correctness through mental calculation or through feedback provided by an associated digital application. The ability to rotate characters enables rapid modification of equations, allowing learners to explore multiple problem variations with minimal effort.

This use case supports foundational math skills, number recognition, and logical reasoning.

### Pattern Recognition and Cognitive Skill Development

In another use case, the invention is employed for pattern recognition and cognitive skill development. Modular units may display symbols, colors, or shapes rather than letters or numbers. Learners may be instructed to form repeating patterns, symmetrical arrangements, or sequences based on rules defined by an educator or game.

By rotating character rings and rearranging modular units, learners engage in problem-solving activities that develop memory, attention, and logical sequencing skills. The physical manipulation of units reinforces cognitive engagement and promotes active learning.

This scenario is particularly suitable for early developmental training and cognitive therapy applications.

### Creative Storytelling and Expression

The invention may also be used as a tool for creative storytelling and expressive play. Modular units displaying letters, symbols, or pictures may be arranged to form names, story prompts, or symbolic narratives. Children may rotate rings to create imaginary words, characters, or themes, fostering creativity and imagination.

Educators may use this scenario in classroom activities where learners collaboratively build stories by modifying displayed characters and symbols. The modular and reconfigurable nature of the device encourages group interaction and cooperative learning.

### Gamified Learning and Challenges

In another use case, the invention is integrated into game-based learning activities. Learners may be challenged to form words, solve equations, or complete sequences within a time limit or under specific constraints. The physical act of rotating and arranging the units adds a game-like dimension that enhances engagement.

When used with a digital application, the device may support scoring, progress tracking, and adaptive difficulty. For example, the application may present challenges, recognize the displayed characters, and provide rewards or feedback based on learner performance.

This scenario enhances motivation and sustained engagement in educational tasks.

### Classroom and Group Learning Environments

The invention is well suited for classroom use, where educators may employ multiple sets of modular units for group activities or individual workstations. The device's durability and lack of loose parts make it practical for repeated use in shared environments.

Teachers may demonstrate spelling or math concepts using a large connected sequence of units, while students follow along with their own sets. The modular design allows easy customization of lesson plans across different grade levels.

### Home Learning and Parental Engagement

In a home learning environment, parents or caregivers may use the invention to support informal education and practice outside of school. The intuitive design allows adults with no specialized training to guide learning activities, while children can independently explore character combinations.

The device may also be used as a screen-free learning tool or, optionally, in conjunction with digital devices for guided instruction and progress monitoring.

### Special Education and Therapeutic Applications

The invention may be used in special education or therapeutic settings, where tactile and visual learning tools are beneficial. The controlled presentation of one character per unit, combined with physical manipulation, can support learners with attention difficulties, learning disabilities, or sensory processing needs.

The modular and customizable nature of the device allows therapists and educators to tailor activities to individual learner requirements.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclosed herein suitably may be practiced in the absence of any element which is not specifically disclosed herein—and in particular embodiment specifically contemplated, is intended to be practiced in the absence of any element which is not specifically disclosed herein.

1. A modular educational device comprising:
a plurality of display modules, each display module including:
a housing; and
a movable character carrier retained within the housing and configured to selectively present one of a plurality of characters through a viewing region of the housing;
wherein the movable character carrier is movable relative to the housing to change a displayed character without removal of the character carrier,
and wherein two or more display modules are detachably connectable to collectively present a sequence of characters.

2. The modular educational device of claim 1, wherein the movable character carrier comprises a rotatable ring.

3. The modular educational device of claim 1, wherein the plurality of characters comprises at least one of alphabetic letters, numerical characters, symbols, punctuation marks, phonetic characters, pictorial icons, or combinations thereof.

4. The modular educational device of claim 1, wherein the viewing region exposes only a single character of the movable character carrier at a time.

5. The modular educational device of claim 1, further comprising a connection mechanism configured to detachably couple adjacent display modules.

6. The modular educational device of claim 5, wherein the connection mechanism permits axial attachment and lateral attachment between adjacent housings.

7. The modular educational device of claim 5, wherein the connection mechanism constrains relative rotation between adjacent housings.

8. The modular educational device of claim 5, wherein the connection mechanism provides repeatable positional alignment of adjacent display modules.

9. The modular educational device of claim 5, wherein the connection mechanism enables tool-free separation by a child.

10. A learning system comprising:
a plurality of physical display modules, each display module including a housing and a movable character carrier configured to display selectable characters; and
an external computing device including a camera and a processor;
wherein the processor is configured to capture image data representing characters displayed by the display modules and to generate instructional output based on recognition of the displayed characters.

11. The learning system of claim 10, wherein the processor is configured to recognize the displayed characters using computer vision-based character recognition.

12. The learning system of claim 10, wherein the display modules are free of embedded electronic sensors and power sources.

13. The learning system of claim 10, wherein the instructional output comprises at least one of spelling validation, pronunciation feedback, numerical evaluation, pattern recognition, progress tracking, or game-based feedback.

14. A method of facilitating learning using modular display units, comprising:
arranging a plurality of display modules;
moving character carriers of the display modules to present selected characters; and
evaluating the presented characters to provide instructional feedback.

15. The method of claim 14, further comprising capturing image data representing the presented characters using an external computing device.

16. The method of claim 15, wherein evaluating the presented characters comprises segmenting individual character regions from the captured image data.

17. The method of claim 16, further comprising comparing recognized characters to a target word, number, or pattern.

18. The method of claim 17, further comprising generating corrective or affirmative instructional feedback based on the comparison.

19. The modular educational device of claim 1, wherein movement of the character carrier produces tactile resistance or an audible clicking sound indicating discrete character positions.

20. The modular educational device of claim 1, wherein at least a portion of the housing is translucent, permitting partial visibility of adjacent characters to provide a directional visual cue.

21. The modular educational device of claim 1, wherein the movable character carrier is interchangeable with another carrier having a different set of characters.

22. The modular educational device of claim 1, wherein each movable character carrier is independently operable without affecting carriers of adjacent display modules.

23. The modular educational device of claim 1, wherein the housing includes rounded edges and dimensions configured for single-handed manipulation by a child.

24. The modular educational device of claim 1, wherein at least one display module optionally includes markings, electronic sensors, or powered components to extend functionality.

25. The method of claim 14, wherein the method is used for teaching at least one of literacy, phonics, numeracy, pattern recognition, or creative expression.
